(19) United States
(12) Patent Application Publication
(10) Pub. No.: US 2018/0297816 A1
(43) Pub. Date: Oct. 18, 2018

(54) RENEWABLE PANEL ASSEMBLY FOR AN ELEVATOR CAR

(71) Applicant: Otis Elevator Company, Farmington, CT (US)

(72) Inventor: Laurent Coldre, La neuville sur essone (FR)

(21) Appl. No.: 15/767,019

(22) PCT Filed: Oct. 8, 2015
(86) PCT No.: PCT/IB2015/001977

§ 371 Date: Apr. 9, 2018

(51) Int. Cl. B66B 11/02; B32B 7/06; B32B 7/08

(52) U.S. Cl. CPC B66B 11/0226; B66B 11/0253; B32B 2419/00; B32B 7/08; B32B 7/06

(57) ABSTRACT

An elevator car (20) includes an interior panel and a multi-layered covering (34) located over the interior panel. The covering (34) includes a plurality of layers (36), with each layer (36) being peelable from an adjacent layer (36) of the plurality of layers (36) located beneath. By removing the outermost layer (36), the aesthetic appearance of the elevator car (20) interior is refreshed.

### BACKGROUND

The present disclosure relates to elevator cars, and more particularly to renewable panel assemblies of elevator cars.

Elevator cars are known to transport occupants between floors of a building. An aesthetically pleasing car interior is desirable and contributes toward occupant comfort and quality of transport. Unfortunately, the high usage and close quarters within elevator cars may cause excessive wear to decorative features placed within a car. It is desirable to improve and/or simplify maintenance of the elevator car that is attributable toward aesthetics.

### SUMMARY

An elevator car according to one, non-limiting, embodiment of the present disclosure includes an interior panel; and a multi-layered covering located over the interior panel, the covering including a plurality of layers, and wherein each layer is peelable from a layer of the plurality of layers disposed beneath.

Additionally to the foregoing disclosure, the interior panel is a structural side panel.

In the alternative or additionally thereto, in the foregoing embodiment, the plurality of layers are laminated.

In the alternative or additionally thereto, in the foregoing embodiment, the elevator car includes an anti-peeling protector covering at least a portion of a perimeter of the covering.

In the alternative or additionally thereto, in the foregoing embodiment, the anti-peeling protector is a bordering frame extending continuously about the perimeter.

In the alternative or additionally thereto, in the foregoing embodiment, the anti-peeling protector includes an elongated member and a removable fastener extending through the covering for engaging the elongated member to the interior panel.

In the alternative or additionally thereto, in the foregoing embodiment, the fastener is threaded.

In the alternative or additionally thereto, in the foregoing embodiment, the layers of the plurality of layers are thermo-plastic.

In the alternative or additionally thereto, in the foregoing embodiment, the elevator car includes a suspended ceiling, and wherein the covering and interior panel extend above the ceiling.

In the alternative or additionally thereto, in the foregoing embodiment, the elevator car includes an anti-peeling protector covering at least a portion of a perimeter of the covering and including a plurality of fasteners disposed above the suspended ceiling extending through the covering and removably engaged to the interior panel.

In the alternative or additionally thereto, in the foregoing embodiment, the elevator car includes a floor; and an elongated lip projecting upward from the floor, and wherein a bottom edge portion of the covering is disposed between and in contact with the interior panel and the lip.

In the alternative or additionally thereto, in the foregoing embodiment, the lip is resiliently flexible.

In the alternative or additionally thereto, in the foregoing embodiment, at least some of the layers of the plurality of layers are different in color.

In the alternative or additionally thereto, in the foregoing embodiment, at least some of the layers of the plurality of layers are translucent.

In the alternative or additionally thereto, in the foregoing embodiment, at least some of the layers of the plurality of layers are aesthetically different from one-another.

In the alternative or additionally thereto, in the foregoing embodiment, the layers of the plurality of layers are removably adhered to one-another.

A renewable panel assembly for an elevator system according to another, non-limiting, embodiment includes a rigid backing; and a multi-layered covering located over the backing, the covering including a plurality of layers, and wherein each layer is peelable from a layer of the plurality of layers disposed beneath.

Additionally to the foregoing embodiment, the renewable panel assembly includes an anti-peeling protector covering at least a portion of a perimeter of the covering.

In the alternative or additionally thereto, in the foregoing embodiment, the multi-layered covering is an aesthetic covering.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 depicts a portion of an elevator car in an exemplary embodiment;

FIG. 2 is a cross section of a renewable panel assembly for the elevator car of FIG. 1;

FIG. 3 is an enlarged cross section of an anti-peeling protector of the assembly taken from circle 3 of FIG. 2; and

FIG. 4 is an enlarged cross section of a bottom edge portion of the assembly taken from circle 4 of FIG. 2.

### DETAILED DESCRIPTION

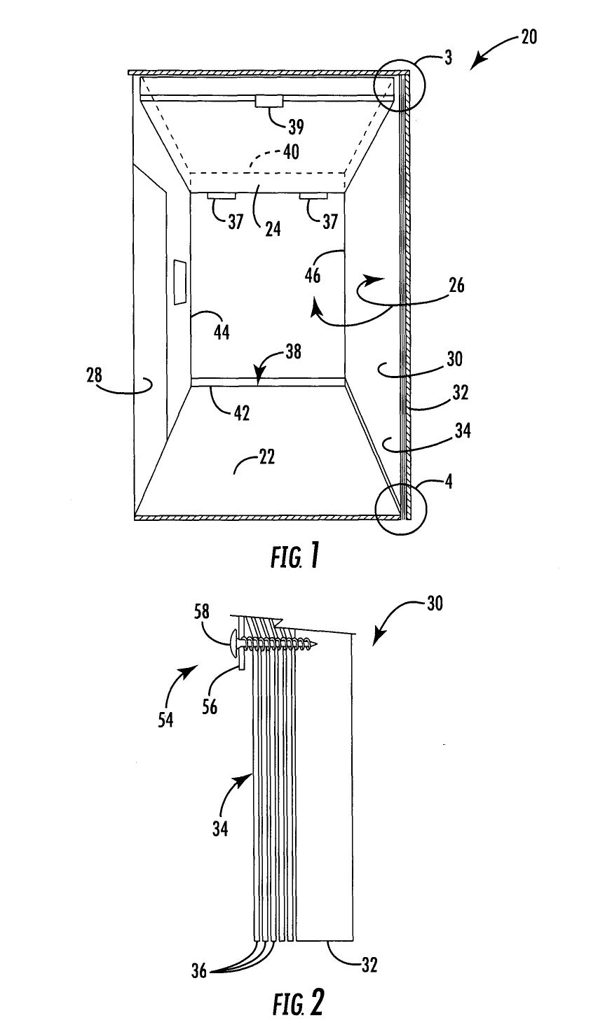

FIG. 1 generally depicts an interior of an elevator car 20 of an elevator system in an exemplary embodiment of the present disclosure. Elevator systems (not shown) are known to be used in occupiable structures or buildings having multiple levels or floors. The elevator system includes a hoistway having boundaries defined by the structure, and at least one elevator car 20 adapted to travel in the hoistway. The elevator car 20 is adapted to carry and transfer occupants between floors. Because of the time occupants spend within the elevator car 20, it is desirable to make the interior of the elevator car aesthetically pleasing.

Each elevator car 20 may include a floor 22, a ceiling 24 that may be decorative, and, as one example, four side walls 26 (three illustrated) extending vertically between the floor and ceiling. At least one of the side walls 26 of the elevator car 20 may generally include an elevator car door 28 as is generally known in the art. As occupants come and go from the elevator car 20, the side walls 26 are generally exposed to wear such as, for example, scratches, scuff marks, small indentations, engrained dirt, and other types of wear not pleasing to the naked eye of an occupant.

Referring to FIGS. 1 and 2, each side wall 26 may include a renewable panel assembly 30 that includes a structural panel or backing 32 and a multi-layered covering 34. The backing 32 may be rigid and/or structural in the sense that the backing is capable of supporting the covering 34 that may otherwise be flexible causing collapse. Moreover, the backing 32 may also have structural traits enabling the backing to generally be the side wall 26 such that occupants may lean against the wall without experiencing wall give or flexing. The multi-layered covering 34 includes a plurality of layers 36 that may be peelably removed from one-another. Alternatively, the layers 36 may be removably adhered to one-another by any variety of techniques known in the art of, for example, separable laminates.

The ceiling 24 may be suspended from various structural members of the elevator car 20 and may facilitate a decor that is pleasing to the eye (e.g. glass panels supported by decorative framework, etc.), may support light fixtures, and may prevent occupant access to the structural members. The ceiling 24 is removable and may generally include hinges 37 on one side with a locking mechanism 39 on the other side. The locking mechanism 39 may require a custom key or tool not typically available to an occupant during normal elevator car 20 use.

The renewable panel assembly 30 may include a continuously extending perimeter 38 having opposite top and bottom edge portions 40, 42 and opposite side edge portion 44, 46 each extending between the top and bottom edge portions 40, 42. Each layer 36 may generally be exposed along the edge or perimeter 38 of the renewable panel assembly 30. When peeling an outermost layer from the plurality of layers 36, access to at least one of the edge portions 40, 42, 44, 46 is desirable in order to separate the outer layer from the layers beneath. Moreover, any segment of the perimeter 38 may be loosely layered (i.e., not adhered to one-another), to simplify the peeling process. Such a loosely layered segment may appear, visually, different from the remainder of the renewable panel assembly 30, thus concealment of such a segment, if not the entire perimeter 38, is desirable. It is further contemplated and understood that a perimeter segment may be creased enabling easier separation of layers.

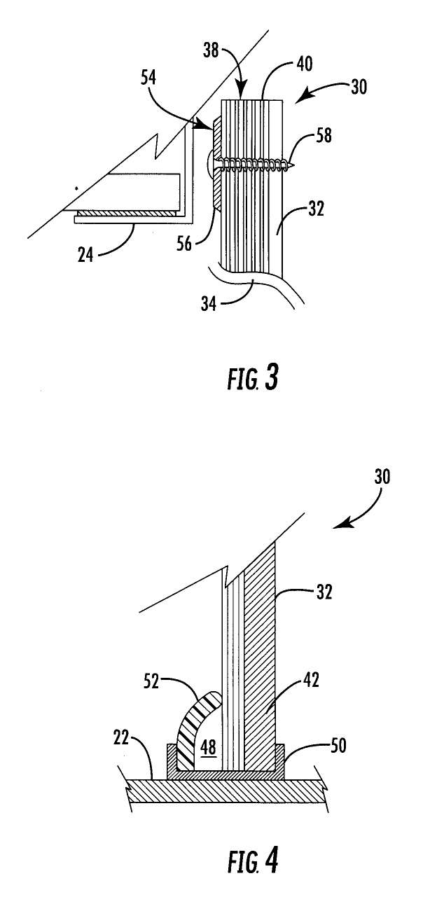

Referring to FIGS. 3 and 4, to conceal the exposed edges from the view of the occupants, the bottom edge portion 42 may rest in a channel 48 that extends along the floor 22. The channel 48 may generally be defined by the floor 22, (e.g., or channel member 50 that extends along the floor 22) and a lip 52 that may extend longitudinally along the floor 22 and projects laterally upward from the floor. The portion of the plurality of layers 36 as part of the bottom edge portion 42 may be located between the lip 52 and the backing 32. The lip 52 may further be resiliently flexible and may be in resilient contact with the outermost layer36 of the multi-layered covering 34. The top edge portion 40 of the renewable panel assembly perimeter 38 may be located above the ceiling 24 thus concealing the top edge portion 40 from occupant view. The side edge portions 44, 46 may generally be concealed by the adjacent side walls 26. Concealment of edge portions 40, 42, 44, 46 is aesthetically desirable and limits any tampering by occupants.

The renewable panel assembly 30 may further include an anti-peeling protector 54 that inhibits occupant tampering and/or premature peeling of the covering 34. The protector 54 may generally be located above the ceiling 24 and may include an elongated member or bar 56 and a plurality of fasteners 58. Each fastener 58 may extend through the member 56 and covering 34 to releasably secure to the backing 32. It is further contemplated and understood that the anti-peeling protector 54 may not be located above the ceiling 24 and/or may be a continuous frame extending about and concealing the entire perimeter 38. It is further contemplated and understood that the fasteners 58 may be threaded with an enlarged head requiring a custom tool to enable rotation and thereby disengagement.

The layers 36 of the covering 34 may be made of a plastic material that may be flexible and may be thermoplastic. The layers 36 may be releasably adhered together by processes generally known by one skilled in the art such as, for example, lamination. Such processes may include pressure and heat. Other processes may include application of a releasably adhesive applied between the layers 36. Each layer 36 may be translucent, thus exposing a decorative, yet protected, scheme beneath. Alternatively, each layer 36 may be aesthetically different providing occupants of the elevator car 20 a varying decor over time. Yet further, each layer 36 may be of a different color or pattern from the next adjacent layer.

As previously described, the renewable panel assembly 30 may be applied to interior walls 26 and doors 28 of the elevator car 20. It is further contemplated and understood, the panel assembly 30 may also be applied to elevator landing doors (not shown) and other visible surfaces of the elevator system, and external to the elevator car.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

1. An elevator car comprising:
an interior panel; and
a multi-layered covering located over the interior panel, the covering including a plurality of layers, and wherein each layer is peelable from a layer of the plurality of layers disposed beneath.

2. The elevator car set forth in claim 1, wherein the interior panel is a structural side panel.

3. The elevator car set forth in claim 1, wherein the plurality of layers are laminated.

4. The elevator car set forth in claim 1, further comprising:
an anti-peeling protector covering at least a portion of a perimeter of the covering.

5. The elevator car set forth in claim 4, wherein the anti-peeling protector is a bordering frame extending continuously about the perimeter.

6. The elevator car set forth in claim 4, wherein the anti-peeling protector includes an elongated member and a removable fastener extending through the covering for engaging the elongated member to the interior panel.

7. The elevator car set forth in claim 6, wherein the fastener is threaded.

8. The elevator car set forth in claim 1, wherein the layers of the plurality of layers are thermo-plastic.

9. The elevator car set forth in claim 1, further comprising:
a suspended ceiling, and wherein the covering and interior panel extend above the ceiling.

10. The elevator car set forth in claim 9 further comprising:
an anti-peeling protector covering at least a portion of a perimeter of the covering and including a plurality of fasteners disposed above the suspended ceiling extending through the covering and removably engaged to the interior panel.

11. The elevator car set forth in claim 1, further comprising:
a floor; and
an elongated lip projecting upward from the floor, and wherein a bottom edge portion of the covering is disposed between and in contact with the interior panel and the lip.

12. The elevator car set forth in claim 11, wherein the lip is resiliently flexible.

13. The elevator car set forth in claim 1, wherein at least some of the layers of the plurality of layers are different in color.

14. The elevator car set forth in claim 1, wherein at least some of the layers of the plurality of layers are translucent.

15. The elevator car set forth in claim 1, wherein at least some of the layers of the plurality of layers are aesthetically different from one-another.

16. The elevator car set forth in claim 1, wherein the layers of the plurality of layers are removably adhered to one-another.

17. A renewable panel assembly for an elevator system comprising:
a rigid backing; and
a multi-layered covering located over the backing, the covering including a plurality of layers, and wherein each layer is peelable from a layer of the plurality of layers disposed beneath.

18. The renewable panel assembly set forth in claim 17 further comprising:
an anti-peeling protector covering at least a portion of a perimeter of the covering.

19. The renewable panel assembly set forth in claim 17, wherein the multi-layered covering is an aesthetic covering.
